(19) United States
(12) Patent Application Publication
(10) Pub. No.: US 2025/0317920 A1
(43) Pub. Date: Oct. 9, 2025

(54) USER EQUIPMENT, METHOD FOR TRANSMIT BEAM MANAGEMENT IN SIDELINK COMMUNICATION, AND STORAGE MEDIUM

(71) Applicant: GUANGDONG OPPO MOBILE TELECOMMUNICATIONS CORP., LTD., Dongguan (CN)

(72) Inventor: Huei-Ming LIN, Taipei (TW)

(21) Appl. No.: 19/243,445

(22) Filed: Jun. 19, 2025

Related U.S. Application Data
(63) Continuation of application No. PCT/CN2022/141806, filed on Dec. 26, 2022.

(51) Int. Cl. H04W 72/044; H04B 17/309; H04W 92/18

(52) U.S. Cl. CPC H04W 72/046; H04B 17/309; H04W 92/18

(57) ABSTRACT

A method for transmit beam management in sidelink communication by a user equipment (UE) includes performing a first stage of beam management, by the UE. The first stage of beam management includes the UE performing sidelink transmission using a set of beams to another UE, the set of beams is a representative set of all transmit beams supported by the UE, and the representative set of all transmit beams includes one or more preferred beams.

### CROSS REFERENCE TO RELATED APPLICATION(S)

This application is a continuation of International Application No. PCT/CN2022/141806, filed Dec. 26, 2022, the entire disclosure of which is incorporated herein by reference.

### BACKGROUND OF DISCLOSURE

### 1. Field of the Disclosure

The present disclosure relates to the field of communication systems, and more particularly, to a user equipment (UE) and a method for transmit beam management in sidelink communication, which can provide a good communication performance and/or provide high reliability.

### 2. Description of the Related Art

In 3rd generation partnership project (3GPP) Release 16, the sidelink technology has been developed based on the latest 5th generation (5G) new radio (NR) access system including the support of frequency range 1 (FR1) bands (410 MHz-7125 MHz), frequency range 2 (FR2) bands (24250 MHz-71000 MHz) and various OFDM transmission numerologies/sub-carrier spacings (SCSs) (15k Hz, 30k Hz, 60k Hz, and 120k Hz). One of the main motivations to support additional spectrum bands compared to the 4G long term evolution (LTE) system (i.e., frequency range 2, FR2) is the availability of large spectral bandwidth to support high data rate applications and various SCSs to allow very low latency radio transmissions for delay sensitive services. However, main drawbacks of using high frequency bands (i.e., in FR2) for radio transmission are the high attenuation of signal strength over distance from the transmitter (high pathloss) and the system is prone to frequency/phase errors due to the short wavelengths. For the NR sidelink system, it is claimed to support FR2 spectrum bands by introducing a phase tracking reference signal (PT-RS) in Release 16. However, no particular enhancement or feature has been supported in NR sidelink to combat/mitigate the high pathloss issue in FR2.

Therefore, there is a need for a user equipment (UE) and a method for transmit beam management in sidelink communication, which can solve issues in the prior art, provide a transmit beam management for sidelink communication, lower the transmission and UE processing overhead without sacrificing the accuracy/correctness of selecting and reporting a best beam by a receiver UE (Rx-UE), achieve a more resource efficient beam sweeping and selection process, achieve faster beam selection and reporting, complete the entire beam selection and management process using two iterations/reports from the Rx-UE, provide a good communication performance, and/or provide high reliability.

### SUMMARY

In a first aspect of the present disclosure, a method for transmit beam management in sidelink communication by a user equipment (UE) includes performing a first stage of beam management, by the UE, wherein the first stage of beam management includes the UE performing sidelink transmission using a set of beams to another UE, the set of beams is a representative set of all transmit beams supported by the UE, and the representative set of all transmit beams includes one or more preferred beams.

In a second aspect of the present disclosure, a user equipment (UE) includes a memory configured to store instructions, a transceiver, and a processor coupled to the memory and the transceiver and configured to execute the instructions stored in the memory to cause the UE to perform the above method.

In a third aspect of the present disclosure, a non-transitory machine-readable storage medium has stored thereon instructions that, when executed by a computer, cause the computer to perform the above method.

### BRIEF DESCRIPTION OF DRAWINGS

In order to illustrate the embodiments of the present disclosure or related art more clearly, the following figures will be described in the embodiments are briefly introduced. It is obvious that the drawings are merely some embodiments of the present disclosure, a person having ordinary skill in this field can obtain other figures according to these figures without paying the premise.

FIG. 1 is a block diagram of user equipments (UEs) of communication in a communication network system according to an embodiment of the present disclosure.

FIG. 2 is a schematic diagram illustrating a user plane protocol stack according to an embodiment of the present disclosure.

FIG. 3 is a schematic diagram illustrating a control plane protocol stack according to an embodiment of the present disclosure.

FIG. 4 is a flowchart illustrating a method for transmit beam management in sidelink communication by a UE according to an embodiment of the present disclosure.

FIG. 5 is a schematic diagram illustrating a proposed transmit beam sweeping and management based on broad-sampling according to an embodiment of the present disclosure.

FIG. 6 is a schematic diagram illustrating a proposed transmit beam sweeping and management based on sub-sampling according to an embodiment of the present disclosure.

FIG. 7 is a block diagram of a UE for wireless communication according to an embodiment of the present disclosure.

FIG. 8 is a block diagram of a system for wireless communication according to an embodiment of the present disclosure.

### DETAILED DESCRIPTION OF EMBODIMENTS

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

In the advancement of radio wireless transmission and reception directly between two devices, which is often known as device-to-device (D2D) communication, it was first developed by 3rd generation partnership project (3GPP) and introduced in Release 12 (officially specified as sidelink communication) and improved in Release 13 for Public Safety emergency usage such as mission critical communication to support mainly low data rate and voice type of connection. In 3GPP Release 14, 15 and 16, the sidelink technology was advanced to additionally support vehicle-to-everything (V2X) communication as part of global development of intelligent transportation system (ITS) to boost road safety and advanced/autonomous driving use cases. To further expand the support of sidelink technology to wider applications and devices with limited power supply/battery, the technology was further enhanced in Release 17 in the area of power saving and transceiver link reliability. For Release 18, 3GPP is currently looking to evolve the wireless technology and expand its operation into unlicensed frequency spectrum for larger available bandwidth, faster data transfer rate and easier market adoption of D2D communication using sidelink without requiring any mobile cellular operator's involvement to allocate and configure a part of their expansive precious radio spectrum for data services that do not go throughput their mobile networks.

Since 3GPP Release 16, the sidelink technology has been developed based on the latest 5th generation (5G) new radio (NR) access system including the support of frequency range 1 (FR1) bands (410 MHz-7125 MHz), frequency range 2 (FR2) bands (24250 MHz-71000 MHz) and various OFDM transmission numerologies/sub-carrier spacings (SCSs) (15k, 30k, 60k and 120k). One of the main motivations to support additional spectrum bands compared to the 4G long term evolution (LTE) system (i.e., FR2) is the availability of large spectral bandwidth to support high data rate applications and various SCSs to allow very low latency radio transmissions for delay sensitive services. However, main drawbacks of using high frequency bands (i.e., in FR2) for radio transmission are the high attenuation of signal strength over distance from the transmitter (high pathloss) and the system is prone to frequency/phase errors due to the short wavelengths. For the NR sidelink system, it is claimed to support FR2 spectrum bands by introducing a phase tracking reference signal (PT-RS) in Release 16. However, no particular enhancement or feature has been supported in NR sidelink to combat/mitigate the high pathloss issue in FR2.

### Beamforming and Sweeping in Downlink

Over the downlink (DL) and uplink (UL) of the Uu interface, the concept/feature of beamforming and beam management is developed and introduced since the beginning of the 5G-NR system in Release 15 to improve received signal strength, enhance cellular DL and UL coverages, and minimize radio interference to neighbor cells. In order to enable this beamforming/beam management feature over the Uu interface, particularly in the DL, the concept of beam sweeping is introduced by forming a transmit beam and sweeping it across all the directions in space (both horizontal and vertical spatial domains) that the base station (gNB) supports. Once a UE has received all the transmit beams or as many as it could (according to a pre-defined pattern and time interval), the UE selects a best beam and sends a physical random-access channel (PRACH) to the gNB in a RACH occasion that corresponds to the selected best beam. At the base station, gNB determines the selected best beam from the UE according to the received RACH occasion and uses the selected best beam to complete the random-access procedure in order for the UE to connect to the base station. The same best beam may be also used for subsequent data communication between the gNB and the UE until it is further updated/switched.

### Necessity of Beamforming and Beam Management in Sidelink

As mentioned previously, radio communication in high frequency spectrum (i.e., FR2 bands) may suffer from large attenuation in the transmitted signals and propagation loss through the space compared to the lower frequency bands that the cellular system traditionally operates. Besides the PT-RS that can be used by sidelink communicating devices to correct phase errors in the received carrier frequency and the maximum device transmit power is limited by a device's power class definition, there is currently no other way to improve the communication range/signal coverage but to also support beamforming and beam management for the NR sidelink technology. By improving the signal coverage/communication range for sidelink, it enables a few new use cases and applications for the users, such as enhancing the network coverage from SL relaying on a FR2 carrier and offloading network traffic onto a sidelink FR2 carrier for two UEs that are within the same cell.

### B2B Transmission/Multi-Consecutive Slots Transmission (MCSt)

The main purpose of B2B transmission (which can be also referred as “burst transmission” or “multi-consecutive slot transmission”) is intended for a sidelink (SL) communicating UE to occupy an unlicensed channel continuously for a longer duration of time (i.e., more than one time slot) to mitigate the risk of losing access to the unlicensed channel to a wireless transmission (Tx) device of another radio access technology (RAT). This B2B transmission can be particular important and useful for a SL Tx-UE operating in an unlicensed radio frequency spectrum that has a large size of data transport block (TB) or medium access control (MAC) packet data unit (PDU), requires multiple retransmissions, sidelink hybrid automatic repeat request (SL-HARQ) feedback is disabled, and/or with a short latency requirement (small packet delay budget, PDB). When the unlicensed wireless channel is busy/congested (e.g., with many devices trying to access the channel simultaneously for transmission), it can be difficult and take up a long time to gain access to the channel due to the random backoff timer and priority class category in the LBT procedure. And hence, when a UE finally has a chance/opportunity to gain access to the wireless channel for a channel occupancy time (COT) length which may last for a few milliseconds (e.g., 2 ms, 4 ms, 6 ms, or 10 ms), the intention is to retain the channel access for as long as possible (e.g., all or most of the COT length) to send as much data as possible by continuously transmitting in the unlicensed channel such that wireless devices of other RATs would not have a chance to access the channel.

In some embodiments, for the present proposed transmit beam management for sidelink communication (e.g., in FR2 range), transmit beams are selectively/strategically sweeps across different directions by a transmitter UE (Tx-UE) based on a beam sampling principle during beam selection, tracking and updating processes to lower the transmission and UE processing overhead without sacrificing the accuracy/correctness of selecting and reporting a best beam by a receiver UE (Rx-UE). Other benefits from using the proposed transmit beam sweeping and management methods for SL communication may also include:

Reduced sweeping/sampling of transmit beams may provide also a faster beam selection process and less SL resources are used. This equivalently means a more resource efficient beam sweeping and selection process can be achieved.

Reduced sweeping of transmit beams also means less measurement and computation of beams received at the Rx-UE. Then faster selection and reporting is achieved.

In most cases, two iterations/reports from the Rx-UE are sufficient to complete the entire beam selection and management process.

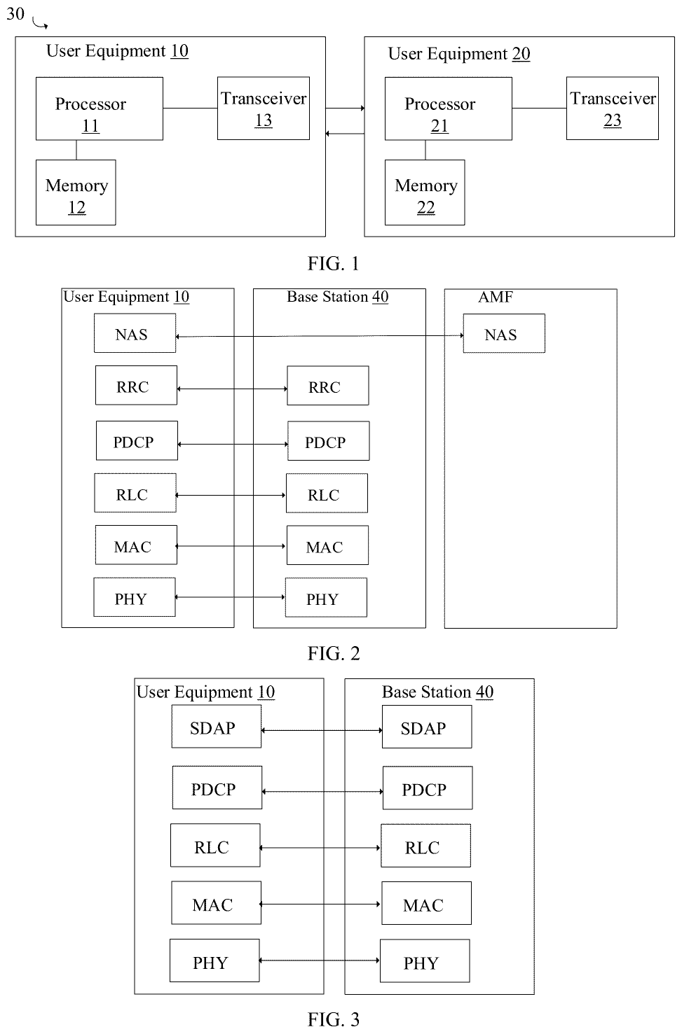

FIG. 1 illustrates that, in some embodiments, one or more user equipments (UEs) 10 (such as a first UE) and one or more user equipments (UEs) 20 (such as a second UE) of communication in a communication network system 30 according to an embodiment of the present disclosure are provided. The communication network system 30 includes one or more UEs 10 and one or more UE 20. The UE 10 may include a memory 12, a transceiver 13, and a processor 11 coupled to the memory 12 and the transceiver 13. The UE 20 may include a memory 22, a transceiver 23, and a processor 21 coupled to the memory 22 and the transceiver 23. The processor 11 or 21 may be configured to implement proposed functions, procedures and/or methods described in this description. Layers of radio interface protocol may be implemented in the processor 11 or 21. The memory 12 or 22 is operatively coupled with the processor 11 or 21 and stores a variety of information to operate the processor 11 or 21. The transceiver 13 or 23 is operatively coupled with the processor 11 or 21 and transmits and/or receives a radio signal.

The processor 11 or 21 may include application-specific integrated circuit (ASIC), other chipset, logic circuit and/or data processing device. The memory 12 or 22 may include read-only memory (ROM), random access memory (RAM), flash memory, memory card, storage medium and/or other storage device. The transceiver 13 or 23 may include baseband circuitry to process radio frequency signals. When the embodiments are implemented in software, the techniques described herein can be implemented with modules (e.g., procedures, functions, and so on) that perform the functions described herein. The modules can be stored in the memory 12 or 22 and executed by the processor 11 or 21. The memory 12 or 22 can be implemented within the processor 11 or 21 or external to the processor 11 or 21 in which case those can be communicatively coupled to the processor 11 or 21 via various means as is known in the art.

The communication between UEs relates to vehicle-to-everything (V2X) communication including vehicle-to-vehicle (V2V), vehicle-to-pedestrian (V2P), and vehicle-to-infrastructure/network (V2I/N) according to a sidelink technology developed under 3rd generation partnership project (3GPP) long term evolution (LTE) and new radio (NR) releases 17, 18 and beyond. UEs are communicated with each other directly via a sidelink interface such as a PC5 interface. Some embodiments of the present disclosure relate to sidelink communication technology in 3GPP NR release 17 and beyond, for example providing cellular-vehicle to everything (C-V2X) communication.

In some embodiments, the UE 10 may be a sidelink packet transport block (TB) transmission UE (Tx-UE). The UE 20 may be a sidelink packet TB reception UE (Rx-UE) or a peer UE. The sidelink packet TB Rx-UE can be configured to send ACK/NACK feedback to the packet TB Tx-UE. The peer UE 20 is another UE communicating with the Tx-UE 10 in a same SL unicast or groupcast session.

FIG. 2 illustrates an example user plane protocol stack according to an embodiment of the present disclosure. FIG. 2 illustrates that, in some embodiments, in the user plane protocol stack, where service data adaptation protocol (SDAP), packet data convergence protocol (PDCP), radio link control (RLC), and media access control (MAC) sublayers and physical (PHY) layer (also referred as first layer or layer 1 (L1) layer) may be terminated in a UE 10 and a base station 40 (such as gNB) on a network side. In an example, a PHY layer provides transport services to higher layers (e.g., MAC, RRC, etc.). In an example, services and functions of a MAC sublayer may comprise mapping between logical channels and transport channels, multiplexing/demultiplexing of MAC service data units (SDUs) belonging to one or different logical channels into/from transport blocks (TBs) delivered to/from the PHY layer, scheduling information reporting, error correction through hybrid automatic repeat request (HARQ) (e.g. one HARQ entity per carrier in case of carrier aggregation (CA)), priority handling between UEs by means of dynamic scheduling, priority handling between logical channels of one UE by means of logical channel prioritization, and/or padding. A MAC entity may support one or multiple numerologies and/or transmission timings. In an example, mapping restrictions in a logical channel prioritization may control which numerology and/or transmission timing a logical channel may use. In an example, an RLC sublayer may supports transparent mode (TM), unacknowledged mode (UM) and acknowledged mode (AM) transmission modes. The RLC configuration may be per logical channel with no dependency on numerologics and/or transmission time interval (TTI) durations. In an example, automatic repeat request (ARQ) may operate on any of the numerologies and/or TTI durations the logical channel is configured with. In an example, services and functions of the PDCP layer for the user plane may comprise sequence numbering, header compression, and decompression, transfer of user data, reordering and duplicate detection, PDCP PDU routing (e.g., in case of split bearers), retransmission of PDCP SDUs, ciphering, deciphering and integrity protection, PDCP SDU discard, PDCP re-establishment and data recovery for RLC AM, and/or duplication of PDCP PDUs. In an example, services and functions of SDAP may comprise mapping between a QoS flow and a data radio bearer. In an example, services and functions of SDAP may comprise mapping quality of service Indicator (QFI) in downlink (DL) and uplink (UL) packets. In an example, a protocol entity of SDAP may be configured for an individual PDU session.

FIG. 3 illustrates an example control plane protocol stack according to an embodiment of the present disclosure. FIG. 2 illustrates that, in some embodiments, in the control plane protocol stack where PDCP, RLC, and MAC sublayers and PHY layer may be terminated in a UE 10 and a base station 40 (such as gNB) on a network side and perform service and functions described above. In an example, RRC used to control a radio resource between the UE and a base station (such as a gNB). In an example, RRC may be terminated in a UE and the gNB on a network side. In an example, services and functions of RRC may comprise broadcast of system information related to AS and NAS, paging initiated by 5GC or RAN, establishment, maintenance and release of an RRC connection between the UE and RAN, security functions including key management, establishment, configuration, maintenance and release of signaling radio bearers (SRBs) and data radio bearers (DRBs), mobility functions, QoS management functions, UE measurement reporting and control of the reporting, detection of and recovery from radio link failure, and/or non-access stratum (NAS) message transfer to/from NAS from/to a UE. In an example, NAS control protocol may be terminated in the UE and AMF on a network side and may perform functions such as authentication, mobility management between a UE and an AMF for 3GPP access and non-3GPP access, and session management between a UE and a SMF for 3GPP access and non-3GPP access.

When a specific application is executed and a data communication service is required by the specific application in the UE, an application layer taking charge of executing the specific application provides the application-related information, that is, the application group/category/priority information/ID to the NAS layer. In this case, the application-related information may be pre-configured/defined in the UE. (Alternatively, the application-related information is received from the network to be provided from the AS (RRC) layer to the application layer, and when the application layer starts the data communication service, the application layer requests the information provision to the AS (RRC) layer to receive the information.)

In some embodiments, the processor 11 is configured to perform a first stage of beam management, wherein the first stage of beam management includes the processor 11 performing sidelink transmission using a set of beams to another UE 20, the set of beams is a representative set of all transmit beams supported by the UE 10, and the representative set of all transmit beams includes one or more preferred beams. This can solve issues in the prior art, provide a transmit beam management for sidelink communication, lower the transmission and UE processing overhead without sacrificing the accuracy/correctness of selecting and reporting a best beam by a receiver UE (Rx-UE), achieve a more resource efficient beam sweeping and selection process, achieve faster beam selection and reporting, complete the entire beam selection and management process using two iterations/reports from the Rx-UE, provide a good communication performance, and/or provide high reliability.

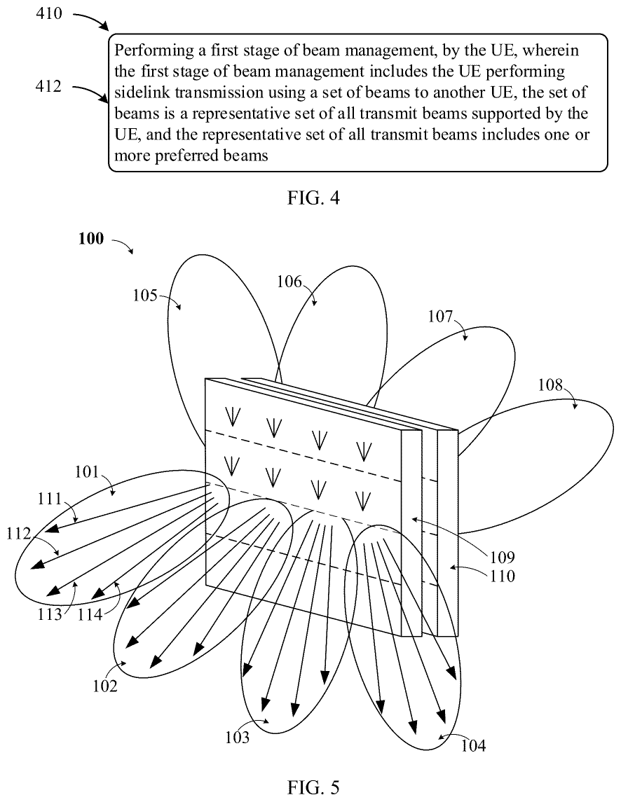

FIG. 4 illustrates a method 410 for transmit beam management in sidelink communication by a UE according to an embodiment of the present disclosure. In some embodiments, the method 410 includes: a block 412, performing a first stage of beam management, by the UE, wherein the first stage of beam management includes the UE performing sidelink transmission using a set of beams to another UE, the set of beams is a representative set of all transmit beams supported by the UE, and the representative set of all transmit beams includes one or more preferred beams. This can solve issues in the prior art, provide a transmit beam management for sidelink communication, lower the transmission and UE processing overhead without sacrificing the accuracy/correctness of selecting and reporting a best beam by a receiver UE (Rx-UE), achieve a more resource efficient beam sweeping and selection process, achieve faster beam selection and reporting, complete the entire beam selection and management process using two iterations/reports from the Rx-UE, provide a good communication performance, and/or provide high reliability.

In some embodiments, the method further includes performing a second stage of beam management, by the UE, wherein the second stage of beam management includes the UE performing sidelink transmission using another set of beams to the another UE, wherein the another set of beams is confined within, associated with, close/adjacent to, or in-between the one or more preferred beams from the first stage of beam management. In some embodiments, the UE performing sidelink transmission using the set of beams is according to one or more configured or pre-defined transmission parameters. In some embodiments, the one or more configured or pre-defined transmission parameters include at least one of a number of beams in the representative set of all transmit beams, a transmission periodicity of the representative set of all transmit beams, a number of supported transmit beams per beam in the representative set of all transmit beams, and a sampling gap between beams in the representative set of all transmit beams.

In some embodiments, the one or more preferred beams is reported from the another UE to the UE. In some embodiments, a number of the one or more preferred beams is configured or pre-defined from a range between 1 and up to 4. In some embodiments, a number of the set of beams used by the UE in the first stage of beam management is indicated by the another UE. In some embodiments, the first stage of beam management is performed by the UE for sidelink unicast communication or sidelink groupcast communication. In some embodiments, the representative set of all transmit beams includes a set of broad-beams or a sub-set of all transmit beams. In some embodiments, the sidelink transmission using the representative set of all transmit beams is performed periodically for selection of an initial set of beams and beam tracking/updating, or event triggered based on a beam failure reporting/consistent beam failure indication.

In some embodiments, one or more best beams in the another set of beams from the second stage of beam management is reported from the another UE to the UE. In some embodiments, a number of the one or more best beams is configured or pre-defined from a range between 1 and up to 4. In some embodiments, the second stage of beam management is performed by the UE according to at least one of the following: during an initial selection of beams, where the second stage of beam management has not previously been performed by the UE for the another UE; when there is a change from a last/most recent reported one or more preferred beams from the another UE during the first stage of beam management; and the UE is requested or triggered by the another UE to perform the second stage of beam management based on existing one or more best beams.

In some embodiments, the one or more preferred beams and/or the one or more best beams are determined based on at least one of the following: a received power of sidelink channel state information-reference signal (SL CSI-RSRP), a sidelink received signal strength indicator (RSSI), an estimation of 10% block error rate (BLER) of physical sidelink control channel (PSCCH), a sidelink carrier-to-interference ratio (C/I), and a sidelink signal-to-interference noise ratio (SINR). In some embodiments, the set of broad-beams in the first stage of beam management and beams in the second stage of beam management are in different frequency carriers or in a same frequency carrier. In some embodiments, a beam pattern and/or a periodicity of the set of broad-beams in the first stage of beam management are configured or pre-defined. In some embodiments, a transmit beam pattern of the sub-set of all transmit beams including a periodicity and a sub-sampling gap between the sub-set of all transmit beams are configured or pre-defined. In some embodiments, the transmit beam pattern of the sub-set of all transmit beams are every second, every third, or every fourth transmit beams.

In some embodiments, the UE performing sidelink transmission using the set of beams in the first stage of beam management and/or the another set of beams in the second stage of beam management to the another UE is based on a multi-consecutive slots transmission (MCSt). In some embodiments, reporting from the another UE to the UE of the one or more preferred beams in the first stage of beam management and/or the one or more best beams in the second stage of beam management is based on a PC5 radio resource control (RRC) signaling, a PC5 sidelink control information (SCI) signaling, a physical sidelink feedback channel (PSFCH) transmission, and/or a PC5 medium access control (MAC) control element (CE) signaling.

In the above embodiments, the term “configured” can refer to “pre-configured” and “network configured”. The term “pre-defined” or “pre-defined rules” in the present disclosure may be achieved by pre-storing corresponding codes, tables, or other manners for indicating relevant information in devices (e.g., including a UE and a network device). The specific implementation is not limited in the present disclosure. For example, “pre-defined” may refer to those defined in a protocol. It is also to be understood that in the disclosure, “protocol” may refer to a standard protocol in the field of communication, which may include, for example, an LTE protocol, NR protocol and relevant protocol applied in the future communication system, which is not limited in the present disclosure.

### EXAMPLES

In some embodiments, for the present disclosure of a new inventive management scheme for transmit beams in sidelink (SL) communication, mainly targeting SL unicast and SL groupcast communications, the SL beam management strategy is based on a two stage/step scheme with different scale of transmit beams to minimize the resources and processing efforts needed to determine a set of best beams for the SL communication. To determine the two different scales of transmit beams, there can be two different beam sampling methods as well.

According to the existing design of beam sweeping mechanism adopted in the downlink of 5G-NR system, as mentioned earlier, transmit beams from the base station gNB are swept across all directions and a UE selects a best beam and transmits a random-access preamble in a random-access channel (RACH) occasion that corresponds to the selected best beam. Over the Uu interface in the downlink, a such blind sweep of transmit beams in all directions is necessary to support UEs in the cell that are in a RRC IDLE state and to extend the cell coverage as wide as possible (so that UEs from far can still receive cell system information and connect to the base station gNB). Although a such blind sweep of transmit beams is necessary for the downlink, but it still take up a lot of radio resources to repeatedly transmit synchronization signal block (SSB) in all directions (i.e., up to 64 beams or more). Furthermore, the beam sweeping operation needs to periodically perform over time so that new system information can be conveyed to all UEs in the cell and all new incoming/camping UEs are able to connect to the base station. As such, it is rather seen as a very resource inefficient beam sweeping and management operation. Overall, a such operation may be acceptable since all UEs are connecting/communicating with a same central node, gNB. Therefore, only the central node (gNB) needs to perform the beam sweeping operation.

On the other hand, the sidelink D2D communication is a decentralized operation where there is no central/common communication node that all UEs talks to (i.e., performing data exchange) and all UEs transmit its data information directly with each other. That is, there is no concept of a cell and all UEs are limited by its own communication range/transmit power. In this sense, each sidelink UE is responsible for its own signal coverage and naturally can perform a beamforming/beam management operation to mitigate the high signal attenuation/propagation loss problem associated with radio transmission in FR2. However, if the same Uu downlink beam sweeping strategy is adopted for all UEs in NR sidelink, the transmission overhead of sweeping beams in all directions supported by each Tx-UE would be staggering, the amount of processing and computation that needs to be done by each Rx-UE for beams transmitted by all Tx-UE would be horrendous, and not to mention the coordination needed among all the Tx-UEs to avoid transmission collisions and a half-duplex problem of not being able to receive beams from others while transmitting. As such, a different beam management and beam sweeping strategy is needed to avoid the above-described problems.

### Proposed Transmit Beam Sweeping and Management Methods

In order to minimize the necessity and the amount of sweeping and management of transmit beams from a Tx-UE in sidelink communication, which may subsequently reduce the amount of SL resources and Rx-UE processing time/computation effort, it is proposed to adopt a two stage/step beam management concept scheme with a “sampling” principle in transmit beam sweeping.

For the overall beam management in sidelink communication, which includes different processes of initial transmit beam sweeping from a Tx-UE, selection of transmit beams at a Rx-UE, reporting/indication of the selected best beam(s), tracking plus updating of best beam(s), and detecting and reporting of a beam failure, these different processes can be supported by the proposed two stage/step concept scheme. For certain beam management processes and SL communication cast types, only the 1st stage/step is needed. For others, both the 1st and the 2nd stages/steps can be carried out.

The 1st stage/step of beam management in sidelink communication is a so call “large scale” sampling of Tx-UE's transmit beams in widespread of directions. For this stage/step of the beam management, only a set of broad-beams (Exemplary Method 1) or a sub-set of all transmit beams (Exemplary Method 2) are transmitted by the Tx-UE according to the two proposed beam sampling methods. The general concept of the 1st stage/step of beam management is for a Tx-UE to transmit and sweep across a large scale of directions with minimum number of beams for both an initial and on-going assessments of transmit beams in widespread of directions. Up on reception of the transmitted beams from the Tx-UE, a Rx-UE measures and reports top K preferred beams in the 1st stage/step of beam management, where K can be (pre-)configured or pre-defined from a range between 1 and up to 4. If the measured channel condition is good and remain relative static, the number of widespread of directions (transmit beams from the Tx-UE) in the 1st stage/step could be even further reduced.

As mentioned earlier in some embodiments, this 1st stage/step of beam management where beams are transmitted in widespread of directions and covering a wide area is ideal for the initial sweep and assessment of transmit beams in all directions, and further for an on-going assessment (tracking) of one or more directions in a SL unicast communication and SL groupcast communication when the number of group member UEs is known (connection-oriented groupcast). Additionally, the 1st stage/step of beam management without the Rx-UE measurement and reporting can be also used for SL broadcast communication and SL groupcast communication when the number of group member UEs is unknown (connectionless groupcast), since the communications are intended for surrounding receiver UEs in all directions (broadcast-like transmission) and no down-selection of preferred beam(s) is needed.

The 1st stage/step of large scale sampling may be used in any one of the following operations.
1. Periodic transmission/sweeping of transmit beams in widespread of directions for the purposes of: Selection of initial beam(s) for SL groupcast and unicast communications (e.g., before connection setup) and beam tracking and updating during SL groupcast and unicast communications. Further reduction in number of broad-beam sampling is possible during the SL groupcast and unicast communications. Since the location/position of SL communicating UEs may be fixed (non-moveable), it is sufficient to limit the number of transmit beams from the initial selection to just one or may be including the immediate adjacent ones to account for some movement of position.
2. Event triggered based on beam failure reporting/consistent beam failure for the purpose of beam failure recovery (e.g., in SL groupcast and unicast communications).

The 2nd stage/step of beam management in sidelink communication is a so call “small scale” sampling of Tx-UE's transmit beams that are confined within, associated with, close/adjacent to, or in-between the one or more K preferred beams reported during the 1st stage/step of beam management. For this stage/step of the beam management, one or more “pencil like” fine-beams that are confined within, associated with, close/adjacent to, or in-between the one or more K preferred beams are transmitted/swept across by the Tx-UE according to the two proposed beam sampling methods (Exemplary Method 1 and Exemplary Method 2) for the purpose of fine tuning a more precise transmit beam for SL communication in a direction that may provide the most performance gain in term of signal coverage, minimum interference, highest decoding reliability, and/or received signal strength for the Rx-UE. Up on reception of the transmitted beams from the Tx-UE, the Rx-UE measures and reports a final selection of best L beams, where L can be (pre-)configured or pre-defined from a range between 1 and up to 4.

The 2nd stage/step of small-scale sampling of transmit beams in fine directions may not need to be performed every time after the 1st stage/step of large-scale sampling of transmit beams in widespread of directions. As mentioned earlier, the location/position of SL communicating UEs may be fixed, fixed relative to each other, or moving very slowly. In these cases, the likelihood of updating/selecting a new best fine-beam is quite small. As such, the need to for a Tx-UE to perform a 2nd stage/step of small-scale sampling of fine-beams may be limited to one or more of the following scenarios/triggers.
1. During the initial selection of beams, where the 2nd stage/step of small-scale sampling of fine-beams has not previously been performed by the Tx-UE for a RX-UE such as a particular Rx-UE.
2. When there is a change in reported K preferred beam(s) from the past by the Rx-UE during the 1st stage of large-scale sampling of transmit beams in widespread of directions. This signifies there is a change in the communication environment in either the Tx-UE and/or the Rx-UE's locations, or something is blocking the existing beam.
3. The Rx-UE may request/trigger the Tx-UE to perform a 2nd stage small-scale sampling of fine-beams based on an observation in the measurement of the existing best beam(s). For example, due to a slow movement of either the Tx-UE or the Rx-UE, the measurement of the existing/on-going selected best beam(s) is beginning to deteriorate. As such, the existing/on-going selected beam(s) used for SL communication may not be the best beam(s) any longer. As long as the selected preferred beam(s) has not changed in the 1st stage/step of beam management, a small update/switch of the best fine-beam(s) may be necessary.

The transmissions in the 1st stage and/or the transmissions in the 2nd stage of beam management could be based on a multi-consecutive slots transmission (MCSt) in SL communication to enable rapid transmissions of a SL signal in the same direction to mitigate any risk in fast changing of channel conditions in order to achieve an accurate and fair measurement comparison from using the different receive beams. Additionally, by utilizing MCSt for (re)transmissions of a same data TB, which does not require a SL hybrid automatic repeat request (HARQ) feedback, it provides opportunities for training and tracking of receive beams at the Rx-UE to achieve resource efficiency and minimize resource wastage without needing to blindly repeat the same data TB transmission many times or to transmit dummy data. The transmissions in the 1st stage and/or the transmissions in the 2nd stage of beam management could be using PC5 RRC, SCI, PSFCH transmission, and/or MAC CE signaling.

The radio measurement to be used by the Rx-UE for the selection of both the top K preferred beams in the 1st stage/step of large scale sampling or the best L beams in the 2nd stage/step of small scale sampling could be based on one or more of the following. 1. Received power of sidelink channel state information-reference signal (CSI-RS): SL CSI-RSRP. 2. Sidelink received signal strength indicator (RSSI). 3. Estimation of 10% block error rate (BLER) of physical sidelink control channel (PSCCH). 4. Sidelink carrier-to-interference ratio (C/I). 5. Sidelink signal-to-interference noise ratio (SINR).

### Exemplary Method 1: Broad-Sampling of Transmit Beams

In the Exemplary Method 1 of broad-sampling of transmit beams, the Tx-UE transmits a set of broad-beams that would largely cover all the transmit beams that are supported by the Tx-UE. Each one of these broad-beams represents a set of “fine” beams and covers a broad range of directions of these fine-beams. The general idea is to transmit a set of broad-sampling of beams to cover a wide range of directions for beam sweeping during the 1st stage/step of beam management for an initial selection of one or more broad-beams by the Rx-UE. Once the initial selection of the one or more broad-beams (top K preferred beams in the 1st stage/step of large-scale beam management) is performed by the Rx-UE and reported to the Tx-UE, the proposed Exemplary Method 1 in the 2nd stage/step of the proposed beam management the Tx-UE then sweep across the fine-beams that were covered by or associated with the reported one or more broad-beams. By doing so, it can significantly reduce the number of transmit beams that a Tx-UE needs to perform beam sweeping for the purpose of a Rx-UE selecting a final/best beam for their SL communication. This type of operation of the 1st stage and 2nd stage of beam management is ideally suited for SL unicast communication and SL groupcast communication with a known number of UEs within the groupcast (e.g., connection-oriented groupcast).

In reference to diagram 100 in FIG. 5, it is assumed a SL Tx-UE device supports two antenna/beam panels and each panel has 16 antenna elements, which can produce/generate 16 fine-beams per panel. Therefore, there can be up to 32 fine-beams supported by the Tx-UE. Instead of performing a beam sweeping across the all 32 fine-beams for a Rx-UE to select a best beam, it is proposed according to the disclosed Exemplary Method 1 to transmit a set of broad-beams that would generally cover all directions of the fine-beams. As illustrated in diagram 100, there are in total 8 broad-beams (101-108) that can be generated by the Tx-UE covering all directions from the both antenna/beam panels (109 and 110). By transmitting and sweeping across these broad-beams, a Rx-UE measures and selects one or more preferred beams and report them back to the Tx-UE. In this case, the Rx-UE selects only broad-beam 101 based on measurement outcome and reports it back to the Tx-UE. Subsequently, the Tx-UE performs a 2nd stage/step of beam sweeping which includes only the fine-beams (111-114) that are covered by the broad-beam 101. The Rx-UE would perform measurement of the transmitted beams and a final selection of a best beam among the fine-beams 111-114, and reports the selected best beam to the Tx-UE to be used for their SL communication. In the end, the total number of beams that had been transmitted by the Tx-UE to reach a final selection of one best beam by the Rx-UE is 8 broad-sampling beams+4 fine-beams=12 total beams. Compare the proposed Exemplary Method 1 to the existing traditional full sweeps of beams used in the DL, there is a reduction in the sweeping of 20 transmit beams, which is around 67% saving in number of required resources, UE computation processing and time delay.

For the proposed Exemplary Method 1 of broad-sampling of transmit beams, there is no restriction or requirement that the broad-beams and the fine-beams in the 2nd stage/step of beam management shall be in a same carrier or in a same frequency range. That is, it is possible for the Tx-UE to perform the 1st stage/step of broad-sampling of transmit beams using a frequency carrier in FR1, and the 2nd stage/step of small scale sweeping of fine-beams using a frequency carrier in FR2. Therefore, it is further proposed for Exemplary Method 1 that the broad-beams in the 1st stage of beam management and the fine-beams in the 2nd stage of beam management process can be in different frequency carriers or in a same frequency carrier.

The beam pattern for the broad-beams in the proposed Exemplary Method 1 can be (pre-)configured or pre-defined in advanced. Depending on UE implementation, different Tx-UE may have different number of antenna panels, arrangement of antenna panels (e.g., 180-degree, 90-degree offset), number of antenna elements per panel, etc. All these can affect the total number of transmit beams and the beam directions that are supported by a Tx-UE. For example, a smartphone UE may implement 2 beam panels with 180-degree offset (back-to-back) and supports a total of 32 beams (16 beams per panel). In this case, the UE may be (pre-)configured or pre-defined to have a total of 8 broad-beams with 4 fine-beams per broad-beam. In another example, a vehicle UE may install 4 beam panels with 90-degree offset (one panel installed at the front bumper bar, one panel for the back bumper bar and two panels for the two sides). In this case, only 4 broad-beams can be sufficient to communicate with surrounding vehicles. Therefore, it is proposed for Exemplary Method 1 that a set of broad-beam patterns (e.g., number of broad-beams, number of fine-beams per broad-beam) and the periodicity (how frequent the broad-sampling of beams can be transmitted) can be (pre-)configured or pre-defined.

### Exemplary Method 2: Sub-Sampling of Transmit Beams

In the Exemplary Method 2 of sub-sampling of transmit beams, the Tx-UE transmits a sub-set of all the transmit beams supported by the Tx-UE. The beam pattern for the sub-set of all the transmit beams (hereafter referred as “sub-set of beams”) can ideally cover a widespread of directions such that a Rx-UE has a full range of beam directions to perform measurement and selection of top K preferred beams during the 1st stage/step of beam management for large scale sampling. Different to Exemplary Method 1, where broad-beams that cover all the transmit beams are transmitted instead of the fine-beams, in Exemplary Method 2 a sub-set of the actual transmit fine-beams supported by the Tx-UE are transmitted. For example, the transmit beam pattern for the sub-set of beams could be every second (gap=2), every third (gap=3) or every fourth (gap=4) transmit beams. Since the transmission of the sub-set of beams is in principle the same concept as channel probing, as it is well understood that if more samples are taken (with a smaller gap between the samples), the better the estimation and the measurement of the channel can be. However, this is also at an expense of more resource usage, higher UE processing and computation demand, and longer delay in transmitting all the samples. Hence, firstly, the transmit beam pattern including the periodicity (how frequent the sub-sampling of beams can be transmitted) and the sub-sampling gap between the sub-set of beams can be (pre-)configured or pre-defined.

Once the sub-set of beams are transmitted by the Tx-UE, the Rx-UE can perform measurement on the transmitted sub-set of beams, an initial selection of one or more beams (top K preferred beams) and reporting the selected beams back to the Tx-UE during the 1st stage/step of beam management. It is then based on the reported beams, for the 2nd stage/step of beam management (small scale sampling of Tx-UE's fine-beams), the Tx-UE transmits/sweeps across all of the transmit beams/fine-beams that are in-between and including the reported beams (just in case the channel condition has changed since the 1st stage/step of beam management) for the Rx-UE to perform a final selection of best L beams and report them back to the Tx-UE. Similar to the proposed Exemplary Method 1, this type of operation of transmitting a sub-set of sampled beams in the 1st stage/step of beam management and transmitting a sub-set of fine-beams based on a set of reported preferred beams in the 2nd stage/step of beam management is ideally suited for SL unicast communication and SL groupcast communication with a known number of UEs within the groupcast (e.g., connection-oriented groupcast).

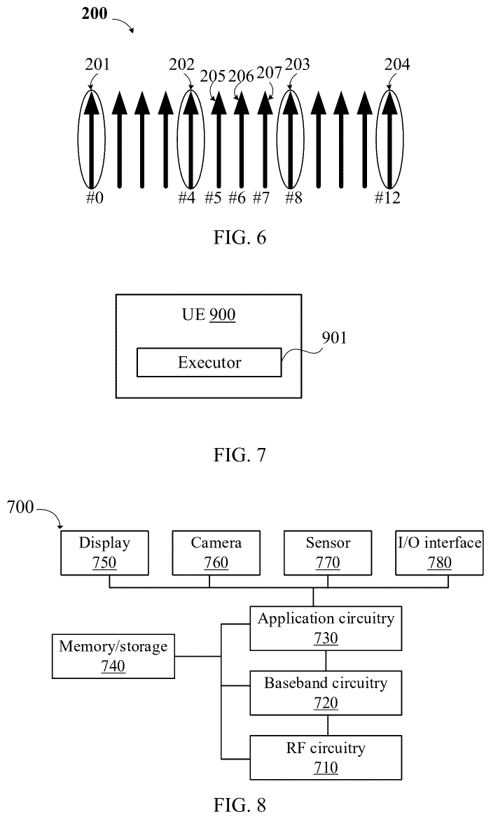

In reference to diagram 200 in FIG. 6, it is assumed a SL Tx-UE device supports and capable of transmitting 13 transmit beams/fine-beams Instead of performing a beam sweeping across the all 13 fine-beams for a Rx-UE to select a best beam, it is proposed according to the disclosed Exemplary Method 2 to transmit a sub-set of beams that would generally cover a widespread of directions as the fine-beams. As shown in diagram 200, a sub-set of 4 transmit beams/fine-beams (201, 202, 203, 204) are selected for the 1st stage/step of beam management. By transmitting and sweeping across these sub-set of beams, a Rx-UE measures and reports one or more preferred beams back to the Tx-UE. In this case, the Rx-UE selects transmit beams 202 and 203 based on measurement outcome and reports them back to the Tx-UE. Subsequently, the Tx-UE performs a 2nd stage/step of beam sweeping which includes only the fine-beams (202, 205, 206, 207, 203) that are in-between and including the reported preferred beams (202 and 203). The Rx-UE would perform measurement of the transmitted fine-beams and a final selection of a set of L best beams among the fine-beams (202, 205, 206, 207, 203), and reports the selected best beams to the Tx-UE to be used for their SL communication. In the end, the total number of beams that had been transmitted by the Tx-UE to reach a final selection of the L best beam by the Rx-UE is 4 sub-sampling beams from the 1st stage/step+5 fine-beams from the 2nd stage/step=9 total beams. Compare the proposed Exemplary Method 2 to the existing traditional full sweeps of beams used in the DL, there is a reduction in the sweeping of 4 transmit beams, which is around 31% saving in number of required resources, UE computation processing and time delay. If the supported total number of transmit beams is larger than 13, the end saving of resources and processing time would be even higher. For example, if the total number of supported transmit beams is 32, the saving would be around 72%.

In summary, in order to minimize the number of resources and the amount of effort to perform beam management in NR sidelink communication, it is proposed in some embodiments of the present disclosure to adopt a principle/approach of “beam sampling”. Based on the “beam sampling” approach, the overall beam management is separated into two stages/steps of operation including 1st stage/step of beam management and 2nd stage/step of beam management. During 1st stage/step of beam management, Tx-UE performs sidelink transmission using a set of beams that is a representative set of all the transmit beams supported by the Tx-UE according to a (pre-)configured or pre-defined transmission parameters (beam pattern), including at least one of a number of beams in the representative set, transmission periodicity of the representative set of beams, number of supported transmit beams per beam in the representative set, and a sampling gap between the beams in the representative set. During 2nd stage/step of beam management, Tx-UE transmits another set of beams (fine-beams) that are confined within, associated with, close/adjacent to, or in-between the reported one or more K preferred beams from the 1st stage/step of beam management.

FIG. 7 illustrates a UE 900 for wireless communication according to an embodiment of the present disclosure. The UE 900 includes an executor 901 configured to perform a first stage of beam management, wherein the first stage of beam management includes the executor 901 performing sidelink transmission using a set of beams to another UE, the set of beams is a representative set of all transmit beams supported by the UE 900, and the representative set of all transmit beams includes one or more preferred beams. This can solve issues in the prior art, provide a transmit beam management for sidelink communication, lower the transmission and UE processing overhead without sacrificing the accuracy/correctness of selecting and reporting a best beam by a receiver UE (Rx-UE), achieve a more resource efficient beam sweeping and selection process, achieve faster beam selection and reporting, complete the entire beam selection and management process using two iterations/reports from the Rx-UE, provide a good communication performance, and/or provide high reliability.

In some embodiments, the executor 901 is further configured to perform a second stage of beam management, wherein the second stage of beam management includes the executor 901 performing sidelink transmission using another set of beams to the another UE, wherein the another set of beams is confined within, associated with, close/adjacent to, or in-between the one or more preferred beams from the first stage of beam management. In some embodiments, the executor 901 performing sidelink transmission using the set of beams is according to one or more configured or pre-defined transmission parameters. In some embodiments, the one or more configured or pre-defined transmission parameters include at least one of a number of beams in the representative set of all transmit beams, a transmission periodicity of the representative set of all transmit beams, a number of supported transmit beams per beam in the representative set of all transmit beams, and a sampling gap between beams in the representative set of all transmit beams.

In some embodiments, the one or more preferred beams is reported from the another UE to the UE 900. In some embodiments, a number of the one or more preferred beams is configured or pre-defined from a range between 1 and up to 4. In some embodiments, a number of the set of beams used by the UE 900 in the first stage of beam management is indicated by the another UE. In some embodiments, the first stage of beam management is performed by the executor 901 for sidelink unicast communication or sidelink groupcast communication. In some embodiments, the representative set of all transmit beams includes a set of broad-beams or a sub-set of all transmit beams. In some embodiments, the sidelink transmission using the representative set of all transmit beams is performed periodically for selection of an initial set of beams and beam tracking/updating, or event triggered based on a beam failure reporting/consistent beam failure indication.

In some embodiments, one or more best beams in the another set of beams from the second stage of beam management is reported from the another UE to the UE 900. In some embodiments, a number of the one or more best beams is configured or pre-defined from a range between 1 and up to 4. In some embodiments, the second stage of beam management is performed by the executor 901 according to at least one of the following: during an initial selection of beams, where the second stage of beam management has not previously been performed by the executor 901 for the another UE; when there is a change from a last/most recent reported one or more preferred beams from the another UE during the first stage of beam management; and the executor 901 is requested or triggered by the another UE to perform the second stage of beam management based on existing one or more best beams.

In some embodiments, the one or more preferred beams and/or the one or more best beams are determined based on at least one of the following: a received power of sidelink channel state information-reference signal (SL CSI-RSRP), a sidelink received signal strength indicator (RSSI), an estimation of 10% block error rate (BLER) of physical sidelink control channel (PSCCH), a sidelink carrier-to-interference ratio (C/I), and a sidelink signal-to-interference noise ratio (SINR). In some embodiments, the set of broad-beams in the first stage of beam management and beams in the second stage of beam management are in different frequency carriers or in a same frequency carrier. In some embodiments, a beam pattern and/or a periodicity of the set of broad-beams in the first stage of beam management are configured or pre-defined. In some embodiments, a transmit beam pattern of the sub-set of all transmit beams including a periodicity and a sub-sampling gap between the sub-set of all transmit beams are configured or pre-defined. In some embodiments, the transmit beam pattern of the sub-set of all transmit beams are every second, every third, or every fourth transmit beams.

In some embodiments, the executor 901 performing sidelink transmission using the set of beams in the first stage of beam management and/or the another set of beams in the second stage of beam management to the another UE is based on a multi-consecutive slots transmission (MCSt). In some embodiments, reporting from the another UE to the UE 900 of the one or more preferred beams in the first stage of beam management and/or the one or more best beams in the second stage of beam management is based on a PC5 radio resource control (RRC) signaling, a PC5 sidelink control information (SCI) signaling, a physical sidelink feedback channel (PSFCH) transmission, and/or a PC5 medium access control (MAC) control element (CE) signaling.

Commercial interests for some embodiments are as follows. 1. Solving issues in the prior art. 2. Providing a transmit beam management for sidelink communication. 3. Lowering the transmission and UE processing overhead without sacrificing the accuracy/correctness of selecting and reporting a best beam by a receiver UE (Rx-UE). 4. Achieving a more resource efficient beam sweeping and selection process. 5. Achieving faster beam selection and reporting. 6. Completing the entire beam selection and management process using two iterations/reports from the Rx-UE. 7. Providing good communication performance. 8. Providing high reliability. 9. Some embodiments of the present disclosure are used by 5G-NR chipset vendors, V2X communication system development vendors, automakers including cars, trains, trucks, buses, bicycles, moto-bikes, helmets, and etc., drones (unmanned aerial vehicles), smartphone makers, smart watches, wireless earbuds, wireless headphones, communication devices, remote control vehicles, and robots for public safety use, AR/VR device maker for example gaming, conference/seminar, education purposes, smart home appliances including TV, stereo, speakers, lights, door bells, locks, cameras, conferencing headsets, and etc., smart factory and warehouse equipment including IIoT devices, robots, robotic arms, and simply just between production machines. In some embodiments, commercial interest for the disclosed invention and business importance includes lowering power consumption for wireless communication means longer operating time for the device and/or better user experience and product satisfaction from longer operating time between battery charging. Some embodiments of the present disclosure are a combination of “techniques/processes” that can be adopted in 3GPP specification to create an end product. Some embodiments of the present disclosure relate to mobile cellular communication technology in 3GPP NR Releases 17, 18, and beyond for providing direct device-to-device (D2D) wireless communication services.

FIG. 8 is a block diagram of an example system 700 for wireless communication according to an embodiment of the present disclosure. Embodiments described herein may be implemented into the system using any suitably configured hardware and/or software. FIG. 8 illustrates the system 700 including a radio frequency (RF) circuitry 710, a baseband circuitry 720, an application circuitry 730, a memory/storage 740, a display 750, a camera 760, a sensor 770, and an input/output (I/O) interface 780, coupled with each other at least as illustrated.

The application circuitry 730 may include a circuitry such as, but not limited to, one or more single-core or multi-core processors. The processors may include any combination of general-purpose processors and dedicated processors, such as graphics processors, application processors. The processors may be coupled with the memory/storage and configured to execute instructions stored in the memory/storage to enable various applications and/or operating systems running on the system.

The baseband circuitry 720 may include circuitry such as, but not limited to, one or more single-core or multi-core processors. The processors may include a baseband processor. The baseband circuitry may handle various radio control functions that enables communication with one or more radio networks via the RF circuitry. The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry.

In various embodiments, the baseband circuitry 720 may include circuitry to operate with signals that are not strictly considered as being in a baseband frequency. For example, in some embodiments, baseband circuitry may include circuitry to operate with signals having an intermediate frequency, which is between a baseband frequency and a radio frequency.

The RF circuitry 710 may enable communication with wireless networks using modulated electromagnetic radiation through a non-solid medium. In various embodiments, the RF circuitry may include switches, filters, amplifiers, etc. to facilitate the communication with the wireless network.

In various embodiments, the RF circuitry 710 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the transmitter circuitry, control circuitry, or receiver circuitry discussed above with respect to the user equipment, eNB, or gNB may be embodied in whole or in part in one or more of the RF circuitry, the baseband circuitry, and/or the application circuitry. As used herein, “circuitry” may refer to, be part of, or include an application specific integrated circuit (ASIC), an electronic circuit, a processor (shared, dedicated, or group), and/or a memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules.

In some embodiments, some or all of the constituent components of the baseband circuitry, the application circuitry, and/or the memory/storage may be implemented together on a system on a chip (SOC).

The memory/storage 740 may be used to load and store data and/or instructions, for example, for system. The memory/storage for one embodiment may include any combination of suitable volatile memory, such as dynamic random access memory (DRAM)), and/or non-volatile memory, such as flash memory.

In various embodiments, the I/O interface 780 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface.

In various embodiments, the sensor 770 may include one or more sensing devices to determine environmental conditions and/or location information related to the system. In some embodiments, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite.

In various embodiments, the display 750 may include a display, such as a liquid crystal display and a touch screen display. In various embodiments, the system 700 may be a mobile computing device such as, but not limited to, a laptop computing device, a tablet computing device, a netbook, an ultrabook, a smartphone, a AR/VR glasses, etc. In various embodiments, system may have more or less components, and/or different architectures. Where appropriate, methods described herein may be implemented as a computer program. The computer program may be stored on a storage medium, such as a non-transitory storage medium.

A person having ordinary skill in the art understands that each of the units, algorithm, and steps described and disclosed in the embodiments of the present disclosure are realized using electronic hardware or combinations of software for computers and electronic hardware. Whether the functions run in hardware or software depends on the condition of application and design requirement for a technical plan.

A person having ordinary skill in the art can use different ways to realize the function for each specific application while such realizations cannot go beyond the scope of the present disclosure. It is understood by a person having ordinary skill in the art that he/she can refer to the working processes of the system, device, and unit in the above-mentioned embodiment since the working processes of the above-mentioned system, device, and unit are basically the same. For easy description and simplicity, these working processes will not be detailed.

It is understood that the disclosed system, device, and method in the embodiments of the present disclosure can be realized with other ways. The above-mentioned embodiments are exemplary only. The division of the units is merely based on logical functions while other divisions exist in realization. It is possible that a plurality of units or components are combined or integrated in another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms.

The units as separating components for explanation are or are not physically separated. The units for display are or are not physical units, that is, located in one place or distributed on a plurality of network units. Some or all of the units are used according to the purposes of the embodiments. Moreover, each of the functional units in each of the embodiments can be integrated in one processing unit, physically independent, or integrated in one processing unit with two or more than two units.

If the software function unit is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program codes.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

What is claimed is:

1. A method for transmit beam management in sidelink communication by a user equipment (UE), comprising:
performing a first stage of beam management, by the UE, wherein the first stage of beam management comprises the UE performing sidelink transmission using a set of beams to another UE, the set of beams is a representative set of all transmit beams supported by the UE, and the representative set of all transmit beams comprises one or more preferred beams.

2. The method of claim 1, further comprising performing a second stage of beam management, by the UE, wherein the second stage of beam management comprises the UE performing sidelink transmission using another set of beams to the another UE, wherein the another set of beams is confined within, associated with, close/adjacent to, or in-between the one or more preferred beams from the first stage of beam management.

3. The method of claim 1, wherein the UE performing sidelink transmission using the set of beams is according to one or more configured or pre-defined transmission parameters, wherein the one or more configured or pre-defined transmission parameters comprise at least one of a number of beams in the representative set of all transmit beams, a transmission periodicity of the representative set of all transmit beams, a number of supported transmit beams per beam in the representative set of all transmit beams, and a sampling gap between beams in the representative set of all transmit beams.

4. The method of claim 1, wherein the one or more preferred beams is reported from the another UE to the UE.

5. The method of claim 1, wherein a number of the one or more preferred beams is configured or pre-defined from a range between 1 and up to 4.

6. The method of claim 1, wherein a number of the set of beams used by the UE in the first stage of beam management is indicated by the another UE.

7. The method of claim 1, wherein the first stage of beam management is performed by the UE for sidelink unicast communication or sidelink groupcast communication.

8. The method of claim 1, wherein the representative set of all transmit beams comprises a set of broad-beams or a sub-set of all transmit beams.

9. The method of claim 1, wherein the sidelink transmission using the representative set of all transmit beams is performed periodically for selection of an initial set of beams and beam tracking/updating, or event triggered based on a beam failure reporting/consistent beam failure indication, wherein a number of one or more best beams is configured or pre-defined from a range between 1 and up to 4.

10. The method of claim 2, wherein one or more best beams in the another set of beams from the second stage of beam management is reported from the another UE to the UE.

11. The method of claim 2, wherein the second stage of beam management is performed by the UE according to at least one of the following:
during an initial selection of beams, where the second stage of beam management has not previously been performed by the UE for the another UE;
when there is a change from a last/most recent reported one or more preferred beams from the another UE during the first stage of beam management; and
the UE is requested or triggered by the another UE to perform the second stage of beam management based on existing one or more best beams.

12. The method of claim 10, wherein the one or more preferred beams and/or the one or more best beams are determined based on at least one of the following: a received power of sidelink channel state information-reference signal (SL CSI-RSRP), a sidelink received signal strength indicator (RSSI), an estimation of 10% block error rate (BLER) of physical sidelink control channel (PSCCH), a sidelink carrier-to-interference ratio (C/I), and a sidelink signal-to-interference noise ratio (SINR).

13. The method of claim 8, wherein the set of broad-beams in the first stage of beam management and beams in a second stage of beam management are in different frequency carriers or in a same frequency carrier, and/or wherein a beam pattern and/or a periodicity of the set of broad-beams in the first stage of beam management are configured or pre-defined.

14. The method of claim 8, wherein a transmit beam pattern of the sub-set of all transmit beams including a periodicity and a sub-sampling gap between the sub-set of all transmit beams are configured or pre-defined, wherein the transmit beam pattern of the sub-set of all transmit beams are every second, every third, or every fourth transmit beams.

15. The method of claim 1, wherein the UE performing sidelink transmission using the set of beams in the first stage of beam management to the another UE is based on a multi-consecutive slots transmission (MCSt).

16. The method of claim 2, wherein the UE performing sidelink transmission using the another set of beams in the second stage of beam management to the another UE is based on a multi-consecutive slots transmission (MCSt).

17. The method of claim 4, wherein reporting from the another UE to the UE of the one or more preferred beams in the first stage of beam management is based on a PC5 radio resource control (RRC) signaling, a PC5 sidelink control information (SCI) signaling, a physical sidelink feedback channel (PSFCH) transmission, and/or a PC5 medium access control (MAC) control element (CE) signaling.

18. The method of claim 10, wherein reporting from the another UE to the UE of the one or more best beams in the second stage of beam management is based on a PC5 radio resource control (RRC) signaling, a PC5 sidelink control information (SCI) signaling, a physical sidelink feedback channel (PSFCH) transmission, and/or a PC5 medium access control (MAC) control element (CE) signaling.

19. A user equipment (UE), comprising:
a memory configured to store instructions;
a transceiver; and
a processor coupled to the memory and the transceiver and configured to execute the instructions stored in the memory to cause the UE to:
perform a first stage of beam management, wherein the first stage of beam management comprises the UE performing sidelink transmission using a set of beams to another UE, the set of beams is a representative set of all transmit beams supported by the UE, and the representative set of all transmit beams comprises one or more preferred beams.

20. A non-transitory machine-readable storage medium having stored thereon instructions that, when executed by a computer, cause the computer to:
perform a first stage of beam management, wherein the first stage of beam management comprises the computer performing sidelink transmission using a set of beams to another UE, the set of beams is a representative set of all transmit beams supported by the computer, and the representative set of all transmit beams comprises one or more preferred beams.
